(19) United States
(12) Patent Application Publication
(10) Pub. No.: US 2011/0069627 A1
(43) Pub. Date: Mar. 24, 2011

(54) PEER-ASSISTED TRANSMITTER SIGNAL ATTRIBUTE FILTERING FOR MOBILE STATION POSITION ESTIMATION

(75) Inventors: Vinay Sridhara, Santa Clara, CA (US); Ayman Fawzy Naguib, Santa Clara, CA (US); Alok Aggarwal, Foster City, CA (US)

(73) Assignee: QUALCOMM Incorporated, San Diego, CA (US)

(21) Appl. No.: 12/724,206

(22) Filed: Mar. 15, 2010

Related U.S. Application Data
(60) Provisional application No. 61/160,425, filed on Mar. 16, 2009.

(51) Int. Cl. H04L 12/26

(52) U.S. Cl. 370/252

(57) ABSTRACT

Examples disclosed herein may relate to filtering one or more signal attributes from a given transmitter from use in mobile station position estimation operations based at least in part on variations in signal strength indicators for one or more wireless communications between the transmitter and a plurality of devices.

This application claims priority from U.S. Provisional Application No. 61/160,425, filed Mar. 16, 2009, and entitled “Peer Assisted RSSI Filtering”, assigned to the assignee hereof and expressly incorporated herein in its entirety by reference.

### BACKGROUND

1. Field

Subject matter disclosed herein relates to filtering one or more signal attributes for a given transmitter from use in mobile station position estimation.

2. Information

The position of a mobile station, such as a cellular telephone, may be estimated based on information gathered from various systems. One such system may comprise a cellular communication system comprising a number of terrestrial base stations to support communications for a number of mobile stations. Another such system may comprise a wireless local area network (WLAN) communication system comprising a number of access points (APs) to support communications for a number of mobile stations. Still another example system may comprise a Satellite Positioning System (SPS) comprising a number of satellite vehicles (SVs). A position estimate, which may also be referred to as a position “fix”, for a mobile station may be obtained based at least in part on distances or ranges measured from such a mobile station to one or more transmitters, and also based at least in part on knowledge of the locations of the one or more transmitters.

### SUMMARY

In an aspect, a range may be estimated between a first mobile station and an access point. A confidence value related to the estimated range may be determined based, at least in part, on one or more signal attributes associated with wireless communications among the first mobile station, a second mobile station, and the access point.

### BRIEF DESCRIPTION OF THE FIGURES

Non-limiting and non-exhaustive examples will be described with reference to the following figures, wherein like reference numerals refer to like parts throughout the various figures.

FIG. 1 is a schematic block diagram depicting an example wireless terminal in communication with an example satellite positioning system and an example wireless communication network.

FIG. 2 is a schematic block diagram depicting an example trilateration technique for performing a position fix for a wireless terminal.

FIG. 3 is a schematic block diagram depicting an example communication system including a transmitter and a plurality of mobile stations.

FIG. 4 is a schematic block diagram of an example technique for filtering transmissions from a given transmitter for mobile station position estimation operations.

FIG. 5 is a schematic block diagram of an example process for filtering a signal attribute for a communication from a given transmitter from use in position estimation operations for a given mobile station.

FIG. 6 is a schematic block diagram illustrating an example implementation of a mobile station.

FIG. 7 is a schematic block diagram depicting an example wireless communication system including a plurality of computing platforms comprising one or more transmitters and one or more mobile stations.

### DETAILED DESCRIPTION

As discussed above, a position of a mobile station, such as a cellular telephone, may be estimated based on information gathered from one or more wireless communication systems. Such wireless systems may comprise a number of transmitters to support communications for a number of mobile stations. A position estimate, which may also be referred to as a position “fix”, for a mobile station may be obtained based at least in part on distances or ranges measured or estimated from the mobile station to one or more transmitters, and also based at least in part on knowledge of the known or estimated locations of the one or more transmitters. Ranges from the mobile stations to the transmitters may be estimated, in some cases, based at least in part on signal strength indicators included in some transmissions, and/or based at least in part on signal strengths measured at receiving mobile stations. For example, estimating the range between a mobile station and an access point may comprise the mobile station measuring a signal strength of a beacon signal transmitted by the access point.

As used herein, the term “access point” refers to any device with the ability to receive wireless signals from one or more terminal devices and that may provide access to a network such as a local area network (LAN) or the Internet, for example. An access point may be installed at a fixed terrestrial location, and may facilitate communication in a wireless communication network, such as, for example, a wireless local area network (WLAN). Such a WLAN may comprise a network compliant to or compatible with an IEEE 802.11x standard, although the scope of claimed subject matter is not limited in this respect. Also, in an aspect, an access point may couple a WLAN to the Internet, in an example implementation. In such an implementation, a wireless terminal may gain access to a server located on the Internet by communicating with the access point using protocols compatible with an 802.11x standard. In another aspect, an access point may comprise a femtocell utilized to extend cellular telephone service into a business or home. In such an implementation, one or more wireless terminals may communicate with the femtocell via a code division multiple access (CDMA) cellular communication protocol, for example, and the femtocell would provide the wireless terminals access to a larger cellular telecommunication network by way of another broadband network such as the Internet. Of course, these are merely example implementations utilizing one or more wireless terminals and an access point, and the scope of claimed subject matter is not limited in this respect.

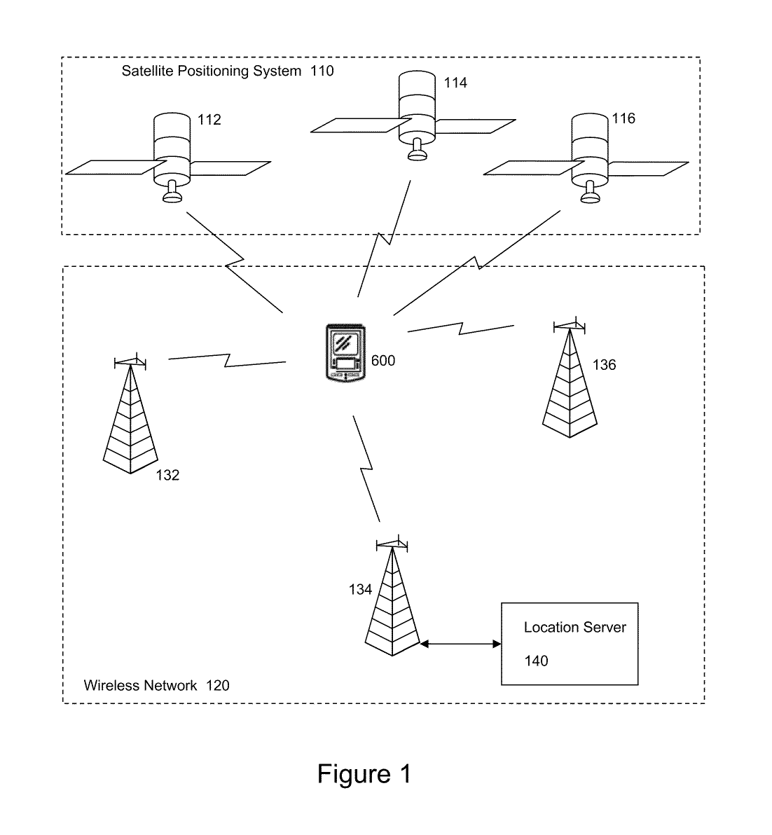

FIG. 1 is a schematic block diagram of a satellite positioning system (SPS) 110 and a wireless network 120 in communication with a wireless terminal (e.g., wireless terminal 600), which may comprise a mobile station, although the scope of claimed subject matter is not limited in this respect. Wireless network 120, for this example, may provide voice and/or data communication for a number of wireless terminals including wireless terminal 600, for example, and may further support position estimation for the wireless terminals in addition to providing voice and/or data communication. Wireless network 120 may comprise any of a number of wireless network types. Wireless network 120 for this example comprises terrestrial-based wireless transmitters 132, 134, and 136 that provide communication for a number of wireless terminals such as, for example, wireless terminal 600. For simplicity, only a few transmitters 132, 134, and 136 are depicted and one wireless terminal 600 is depicted in FIG. 1. Of course, other examples may include additional numbers of transmitters and/or wireless terminals, and the configuration of transmitters depicted in FIG. 1 is merely an example configuration.

In an aspect, SPS 110 may comprise a number of satellite vehicles (SVs), for example, SVs 112, 114, and 116. For an example, SPS 110 may comprise one or more satellite positioning systems, such as GPS, GLONASS and Galileo, although the scope of claimed subject matter is not limited in this respect. In one or more aspects, wireless terminal 600 may receive signals from SVs 112, 114, and 116, and may communicate with one or more of transmitters 132, 134, and 136. For example, wireless terminal 600 may obtain one or more measurements from one or more signals received from one or more of the SVs and/or terrestrial transmitters. However, in some circumstances timing signals from an SPS may not be available. In such a circumstance, wireless terminal 600 may gather propagation delay information and/or signal strength information through communication with one or more of wireless transmitters 132, 134, and/or 136. Wireless terminal 600 may calculate a position location for the wireless terminal based, at least in part, on timing calibration parameters and/or signal strength estimates and/or measurements obtained through communication with one or more of wireless terminals 132, 134, and/or 136, and further based, at least in part, on known position locations of the wireless terminals.

In another aspect, position fix operations may be performed by a network entity such as, for example, location server 140 depicted in FIG. 1, rather than at wireless terminal 600. Such a calculation may be based, at least in part, on information gathered by wireless terminal 600 from one or more of wireless terminals 132, 134, and/or 136 and/or from SVs 112, 114, and/or 116. In a further aspect, location server 140 may transmit a calculated position estimate to wireless terminal 600.

In an aspect, one or more of wireless transmitters 132, 134, and 136 may further couple wireless terminal 600 to one or more other systems and networks, such as, for example, a public switched telephone network (PSTN), a local area network (LAN), and/or a wide area network such as the Internet, to name merely a few examples. For the example depicted in FIG. 1, wireless terminal 600 may access location server 140 by way of transmitter 134. Location server 140 may collect and format location data, may provide assistance to wireless transmitters for position fix operations, and/or may perform computations to obtain position estimates for the wireless terminals.

In an aspect, the locations of one or more wireless transmitters in a wireless system such as wireless network 120 may be reported to a wireless terminal such as wireless terminal 600 by the transmitters themselves. In another aspect, such location information may be provided as part of an almanac, perhaps referred to as a base station almanac, provided by an almanac server entity, over a communication network, for example.

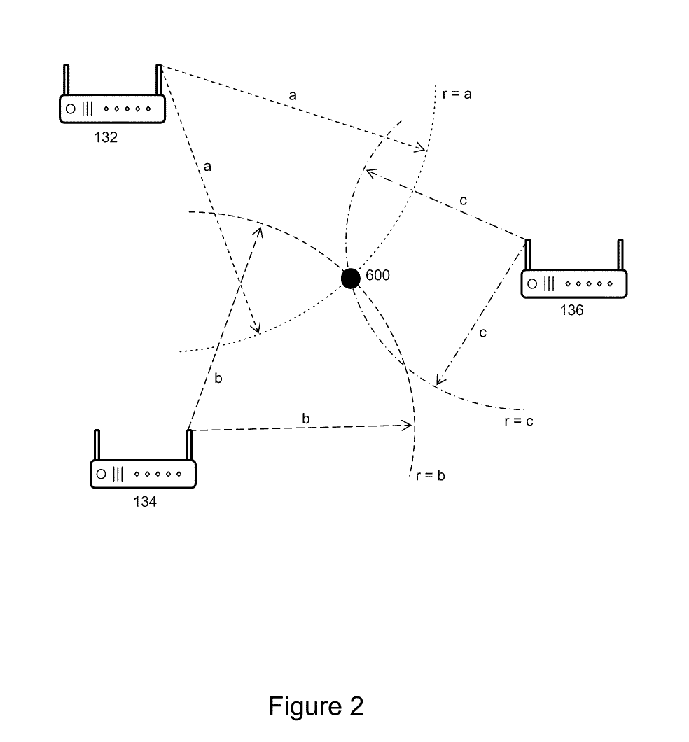

FIG. 2 depicts an example trilateration technique for performing a position fix for wireless terminal 600. For the present example, wireless terminal 600 may receive wireless signals from a number of transmitters. In this example, wireless transmitters 132, 134, and 136 are shown. In other examples, wireless terminal 600 may receive wireless signals from other number of transmitters. In an aspect, to perform a trilateration position fix, signals from three or more wireless transmitters may be received. The respective strengths of the received signals may be measured or otherwise obtained, and the respective signal strengths may be used to estimate a range, or distance, between the wireless transmitters and the wireless terminal. In general, the closer a receiving device is to the transmitter, the stronger the received signal strength. That is, a wireless terminal in relatively close proximity to a transmitter may expect to receive a signal of relatively high signal strength from the transmitter, and a wireless terminal located a greater distance from the transmitter may expect to receive a signal of lower signal strength. Various mathematical models may be utilized to estimate a range between a wireless terminal and a wireless transmitter, and the scope of claimed subject matter is not limited in this respect.

In an aspect, a strength of a signal received at a wireless terminal may be measured by the receiving wireless terminal. In another example, a wireless terminal may transmit a signal to an access point and the access point may measure the signal strength of the received signal and return a signal strength value to the wireless terminal. The scope of claimed subject matter is not limited to any particular technique for obtaining a signal strength value for a communication between a transmitter and a terminal.

For the present example, as depicted in FIG. 2, wireless terminal 600 may receive a transmission from wireless transmitter 132, and based at least in part on the strength of the received signal, a range “a” may be estimated. Similarly, a range “b” may be estimated between transmitter 134 and wireless terminal 600 based at least in part on a strength of a signal transmitted by transmitter 134, and a range “c” may be estimated between transmitter 136 and wireless terminal 600 based at least in part on a strength of a signal transmitted by transmitter 136 received at wireless terminal 600. If the locations of transmitters 132, 134, and 136 are known, as is assumed for the present example, a trilateration technique may be used to determine an intersection point of all of the arcs formed by ranges “a”, “b”, and “c”, and the intersection point may be designated a position fix for wireless terminal 600. If the positions of transmitters 132, 134, and 136 are accurate, and if respective ranges “a”, “b”, and “c” are accurate, an accurate position fix may be obtained for terminal 600. However, if any of the reported positions of the transmitters are inaccurate, such inaccuracy may be reflected in the estimated position of a wireless terminal. Similarly, even if the locations of the transmitters are accurate, any inaccuracies in the range estimations between any of the transmitters and wireless terminal 600 may result in an inaccurate position fix.

Although examples described herein discuss estimating ranges between transmitting devices and receiving devices based at least in part on signal strength, the scope of claimed subject matter is not limited in this respect. Estimating ranges between transmitting devices and receiving devices based at least in part on signal strength is merely one example technique for estimating and/or measuring such ranges. Other techniques may include, for example, measuring and/or estimating such ranges based at least in part on signal phase and/or signal timing. Again, the scope of claimed subject matter is not limited in theses respects.

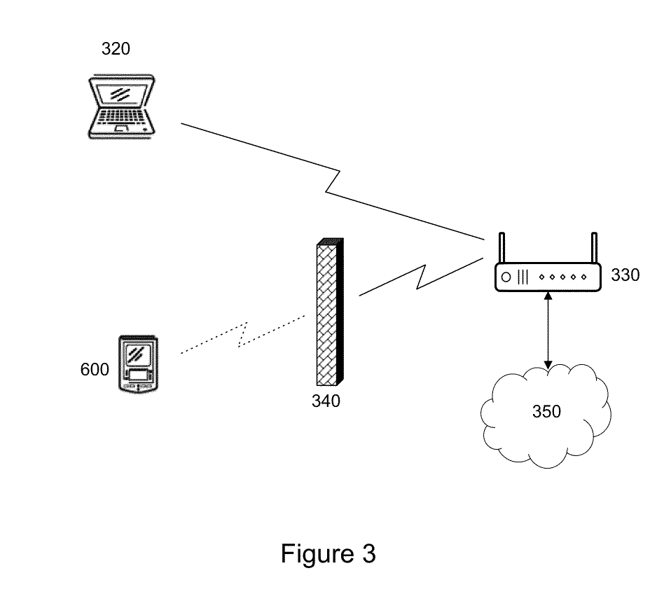

FIG. 3 depicts a situation where an obstacle 340 is present between wireless terminal 600 and a wireless transmitter 330, which may result in a situation where a signal strength measurement for a communication between wireless terminal 600 and wireless transmitter 330 may lead to an inaccurate range measurement. For the present example, wireless terminal 600 comprises a mobile station, and wireless transmitter 330 comprises an access point, although the scope of claimed subject matter is not limited in this respect.

As mentioned above, if an obstacle is present between a transmitter and a wireless terminal, or if there is some other situation resulting in an attenuation of the signal between the access point and the mobile station, a signal strength attribute reported in a transmission received at a wireless terminal from the transmitter may indicate a range between the transmitter and the wireless terminal that is greater than it really is. Similarly, signal strength values may be measured at the wireless terminal for a transmission received from the transmitter, and a range between the terminal and the transmitter may be estimated based on the measured signal strength. Again, range estimates using such a signal strength indication or measurement in the presence of an obstacle or other signal attenuation situation may be inaccurate, and it follows that mobile station position fixes based on the inaccurate range estimate may also be undesirably inaccurate. Techniques for evaluating a level of confidence for estimated ranges between the mobile station and the access point are discussed more fully below.

In an aspect, to determine whether a likely obstacle condition exists, communications between an access point and two or more mobile stations may be analyzed along with one or more communications between the two or more mobile stations to determine whether it appears that an obstacle or any other signal attenuating condition is present between one of the mobile stations and the access point. If such an obstacle or condition is thought to exist, transmissions from that access point may be excluded from position fix operations involving that particular mobile station. Alternatively, the contributions from the access point in the position fix operation may be discounted if an obstacle or other such condition is thought to exist.

In an aspect, a determination may be made as to whether a first mobile station and a second mobile station are approximately equidistant to a transmitter. If the first mobile station and the second mobile station are approximately equidistant to a transmitter, a determination may be made as to whether a signal strength indicator for a communication between the first mobile station and the transmitter has a value at least a threshold value lower than a signal strength indicator value for a communication between the second mobile station and the transmitter. If the indicator value for the transmission for the first mobile station is more than a threshold value less than the indicator for the transmission for the second mobile station, it may be assumed that the difference is due to an obstacle or similar signal attenuating condition. In such a situation, transmissions from the transmitter may lead to inaccurate results if utilized in position fix operations involving the first mobile station and, as a result, contributions from this particular transmitter may be filtered with respect to position fix operations related to the first mobile station. That is, the contributions from the transmitter may be excluded, at least in part, from position fix operations related to the first mobile station.

In an aspect, in a situation where it is determined that an obstacle may exist between a given wireless terminal and a particular wireless transmitter, communications to or from the transmitter may be excluded from use in position fix operations involving the particular wireless terminal until the obstacle condition no longer exists (perhaps, for example, by the mobile station moving to a different location). In such a situation, if excluding the transmitter in question brings the total number of transmitters available for a position fix operation below an acceptable level (e.g., below three in the example of FIG. 2), the transmitter with the obstacle condition may be replaced by one or more additional transmitters, if available. If adequate numbers of transmitters are not available, the position fix operation may be postponed until such a time as an adequate number is available. In a further aspect, if an obstacle is thought to exist between a given wireless terminal and a particular wireless transmitter, rather than completely excluding contributions involving the particular wireless transmitter in performing a position fix for the given wireless terminal, the contributions from the particular wireless transmitter may be weighted in a manner so as to de-emphasize the contributions from the particular transmitter. This may be helpful in situations where additional transmitters are not available to replace a transmitter with a suspected obstacle, and a position fix may be obtained, although with a diminished level of confidence with respect to accuracy.

As used herein, the term access point is meant to include any wireless communication station and/or device used to facilitate communication in a wireless communications system, such as, for example, a wireless local area network, although the scope of claimed subject matter is not limited in this respect. Similarly, the term access point is meant to include a base station that may facilitate wireless communication in a cellular telephone network, for example. Also, as used herein, the terms access point, wireless transmitter, and base station may be used interchangeably, as each term is meant to include any device used to facilitate communication in a wireless communication system. In another aspect, an access point may comprise a wireless local area network (WLAN) access point, for example. Such a WLAN may comprise a network compatible with one or more versions of IEEE standard 802.11 in an aspect, although the scope of claimed subject matter is not limited in this respect. A WLAN access point may provide communication between one or more mobile stations and a network such as the Internet, for example.

As used herein, the term mobile station (MS) refers to a device that may from time to time have a position location that changes. The changes in position location may comprise changes to direction, distance, orientation, etc., as a few examples. In particular examples, a mobile station may comprise a cellular telephone, wireless communication device, user equipment, laptop computer, other personal communication system (PCS) device, personal digital assistant (PDA), personal audio device (PAD), portable navigational device, and/or other portable communication devices. A mobile station may also comprise a processing unit and/or computing platform adapted to perform functions controlled by machine-readable instructions.

Returning once more to FIG. 3, for the present example, the communication system may comprise a wireless system compliant to and/or compatible with one or more versions of IEEE standard 802.11x. Further example wireless communication systems are mentioned, and the scope of claimed subject matter is not limited to any particular wireless network type.

As can be seen in FIG. 3, the present example system comprises an access point 330 that may facilitate communications between/among mobile stations 600 and 320 and a network 350. Network 350 for this example may comprise the Internet, but of course the scope of claimed subject matter is not limited in this respect. For the present example, mobile station 600 may comprise a cellular telephone and mobile station 320 may comprise a notebook computer, although it should be noted that these two device types merely represent two examples of mobile station device types, and the scope of claimed subject matter is not limited in this respect. Other example device types are mentioned, although the list presented is not intended to be an exhaustive list, and other device types are possible in other example implementations of the techniques presented herein in accordance with claimed subject matter.

Also depicted in FIG. 3 is obstacle 340, which for this example may comprise a wall. However, obstacle 340 in this example is meant to represent any type of obstacle and/or any type of condition that would result in an attenuation of a signal transmitted from access point 330 and received by mobile station 600 that is greater than what might be expected in light of an actual range between access point 330 and mobile station 600. For example, mobile stations 600 and 320 are depicted as being approximately equidistant from access point 330. A distance, or range, between mobile station 320 and access point 330 may be expressed as a function of an indicated or measured signal strength based on a range model as follows:

Distance=Range(signal strength(AP 330 to mobile station)) (1)

where Range( ) indicates a range function utilized to estimate a range or distance from a signal strength value and where signal strength(AP 330 to mobile station) indicates a reported signal strength for a transmission from AP 330 to either of the mobile stations (which for this example are equidistant to AP 330). Alternatively, signal strength(AP 330 to mobile station) may represent a signal strength value directly measured at the receiving mobile station.

Now, taking obstacle 340 into consideration, a distance between mobile station 600 and access point 330 may be expressed as:

Distance=Range(signal strength(AP 330 to mobile station+Δ)) (2)

That is, obstacle 340 introduces an error in the distance measurement from access point 330 to mobile station 600 as compared with the distance measurement from access point 330 to mobile station 320.

In an example implementation, one possible function that may be utilized to determine a range between a transmitting device and a receiving device such as in equations (1) and (2), above, may be represented as:

$$d = \sqrt{{P}_{Tx} \frac{{G}_{Tx} \times {G}_{Rx} \times {λ}^{2}}{16 \times {π}^{2} \times {P}_{Rx} \times L}} \qquad ( 3 )$$

where d represents a distance separating a transmitting device and a receiving device, G_{Tx} represents a transmitting device antenna gain, G_{Rx} represents a receiving device antenna gain, λ represents a wavelength with units identical to the units used for d, L represents a system loss factor that is greater than or equal to one, P_{Rx} represents a power for a signal received at the receiving device, and where P_{Tx} represents a power for the signal transmitted at the transmitting device. Of course, this is merely one example of a function that may be utilized to determine a range between a transmitting device and a receiving device, and the scope of claimed subject matter is not limited in this respect.

As noted above, because the signal strength for a communication from access point 330 to mobile station 600 would indicate a range that is greater than the actual range due to obstacle 340, a position fix operation performed by mobile station 600 based at least in part on a transmission from access point 330 to mobile station 600 may result in an undesirably inaccurate position fix.

In an aspect, a received signal strength indicator (RSSI) may be utilized for one or more communications in evaluating the likelihood of an obstacle. RSSI for the examples described herein may comprise an element of versions of IEEE standard 802.11, although the scope of claimed subject matter is not limited in this respect. RSSI may comprise an integer value reported by a receiving device to a transmitting device to indicate a signal strength for a transmission received from the transmitting device. In this manner, mobile station 600 may transmit a signal to access point 330 that may require an acknowledgement transmission from access point 330, and mobile station 600 may compute an RSSI value from the received acknowledgement transmission. Additionally, AP 330 may calculate an RSSI value from the transmission received from mobile station 600, and mobile station 600 may receive an RSSI value back from access point 330 in the acknowledgement transmission in response to the transmission from mobile station 600 or in a subsequent transmission. The RSSI value may indicate the signal strength measured at access point 330 for the signal transmitted by mobile station 600, and mobile station 600 may utilize this value to estimate a range between mobile station 600 and access point 330. Alternatively, mobile station 600 may utilize the RSSI value calculated from the acknowledgement transmission received from AP 330 to estimate the range between mobile station 600 and access point 330. Of course, as explained, such an estimate may assume no significant obstacle or other unusual signal attenuating circumstance. Utilizing RSSI in this manner, a distance, or range, between mobile station 320 and access point 330 may be expressed as a function of RSSI based on a range model as follows:

Distance=RSSI(RSSI(mobile station to AP)) (4)

where RSSI( ) indicates a range function utilized to estimate a range or distance from a reported RSSI value and where RSSI(mobile station to AP) indicates the reported RSSI value for a previous transmission from mobile station 320 to AP 330. The “range” function described herein may comprise any process or technique for estimating a range from a signal strength value.

Again, taking obstacle 340 into consideration, a distance between mobile station 600 and access point 330 may be expressed as:

Distance=RSSI(RSSI(mobile station to AP+Δ)) (5)

where an error term is again introduced to account for obstacle 340. If the error term exceeds a pre-selected threshold, it may be assumed that an obstacle exists between mobile station 320 and access point 330, and the contributions of access point 330 to any position fix operations for mobile station 320 may be excluded or otherwise accounted for in performing position fix operations related to mobile station 320, at least for a period of time.

To summarize an example technique, if mobile station 600 and mobile station 320 are approximately equidistant to access point 330, and if a relatively large difference in signal strength indications exist between communications from mobile station 600 to access point 330 and from mobile station 320 to access point 330, it may be assumed that the difference is due to an obstacle or a similar signal attenuating condition. In such a situation, transmissions from access point 330 may not be reliable if utilized in position fix operations involving mobile station 320.

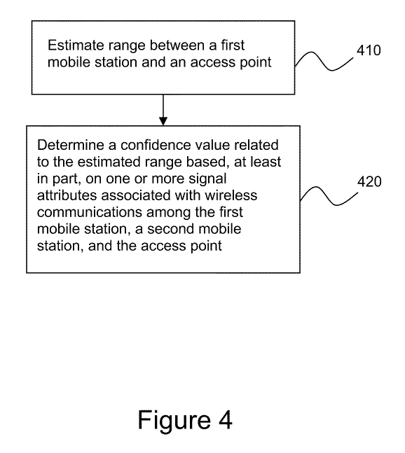

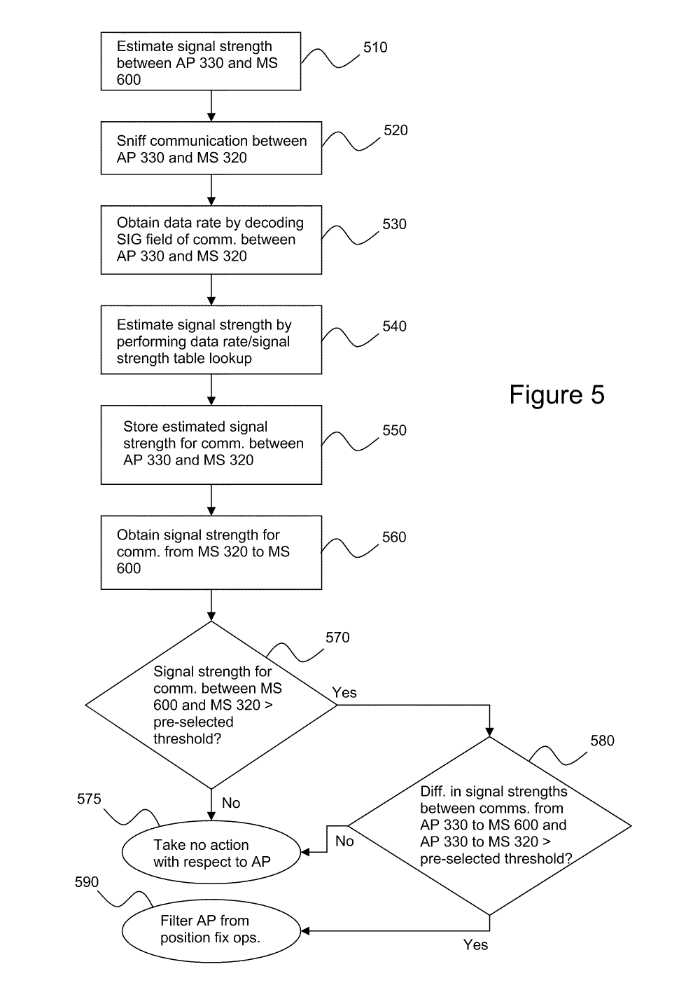

The following example processes depicted in the flow charts of FIGS. 4 and 5 provide additional explanation of the techniques and general principles of example implementations described. In the discussions to follow in connection with FIGS. 4 and 5, it may be helpful to refer to FIG. 3 for improved understanding.

FIG. 4 is a schematic block diagram of an example technique for filtering transmissions from a given transmitter for mobile station position estimation operations. At block 410, a range may be estimated between a first mobile station and an access point. At block 420, a confidence value related to the estimated range may be determined based, at least in part, on one or more signal attributes associated with wireless communications among the first mobile station, a second mobile station, and the access point. In an aspect, and as described above, such signal attributes may comprise signal strength attributes, although the scope of claimed subject matter is not limited in this respect. For example, determining the confidence value related to the estimated range between a first mobile station and an access point may comprise determining the confidence value based, at least in part, on first, second, and third wireless signal strength values, respectively for a wireless communication between the first mobile station and the access point, between a second mobile station and the access point, and between the first mobile station and the second mobile station. At least in part in response to the confidence value falling below a pre-selected threshold value, the access point may be excluded, or “filtered”, from being used in position fix operations for the first mobile station. In an aspect, filtering the access point may include eliminating the access point completely from position fix operations related to the first mobile station for a period of time or more. In another aspect, contributions from the access point for position fix operations for the first mobile station may be considered to a lesser extent, such as by de-weighting such contributions, for example. Example implementations in accordance with claimed subject matter may include all of, less than, or more than, blocks 410-420. Further, the order of blocks 410-420 is merely an example, and the scope of claimed subject matter is not limited in this respect.

FIG. 5 is a schematic block diagram of an example process for filtering a signal attribute for a communication from a given transmitter, access point 330 in this example, from use in position estimation operations for a given mobile station, mobile station 600 in this example, referring back to FIG. 3. At block 510, a signal strength may be estimated for a communication between access point 330 and mobile station 600. The signal strength may be estimated by directly measuring a transmission from access point 330 received at mobile station 600, or in an additional example the signal strength may be estimated by receiving an RSSI value transmitted by access point 330 in response to a communication transmitted by mobile station 600 to access point 330. The scope of claimed subject matter is not limited to any particular technique for estimating a signal strength, and example implementations in accordance with claimed subject matter may utilize any technique for estimating a signal strength for a communication between two devices in a wireless communication system.

At block 520, a communication between access point 330 and mobile station 320 may be sniffed by mobile station 600. As used herein, the term sniff refers to any technique whereby one wireless terminal receives and analyzes in some way a communication intended for another receiving device. For the present example, and as depicted at block 530, a signal (SIG) field of the communication between access point 330 and mobile station 320 may be decoded to obtain a data rate for the aforementioned communication. Further, as depicted at block 540, mobile station 600 may estimate a signal strength for a communication between access point 330 and mobile station 320 by performing a look-up to a local data rate/signal strength table. In such an implementation, the values of the data rate/signal strength table would be stored in a memory at mobile station 600 at an earlier point in time, perhaps as part of the manufacturing process. In this manner, if mobile station 600 has access to a data rate for a particular communication, mobile station 600 may estimate the signal strength for that communication as experienced at the receiving device by performing a simple table look-up. At block 550, the estimated signal strength for the communication between access point 330 and mobile station 320 may be stored in a memory for later retrieval. Also, obtaining the signal strength value for the wireless communication between mobile station 320 and access point 330 may comprise mobile station 600 sniffing the wireless communication to receive an RSSI value included as part of the wireless communication intended for mobile station 320.

In obtaining the data rate for the communication between access point 330 and mobile station 320, note that mobile station 600 may obtain such information even if mobile station 600 is unable to decode the communication packet due to low RSSI and/or high data rate. This is possible due to the SIG field of the preamble of the packet being sent at the lowest data rate, for an example implementation. Of course, the scope of claimed subject matter is not limited to these specific details.

In another aspect of the present example, a signal strength may be obtained by mobile station 320 for a communication transmitted from mobile station 320 to mobile station 600, as depicted at block 560. The signal strength for the communication transmitted by mobile station 320 and received at mobile station 600 may provide an indication as to the range or distance between the two mobile stations. If, as indicated in block 560, the communication is transmitted from mobile station 320 and received at mobile station 600, the signal strength may be obtained by direct measurement. If, however, mobile station 600 transmits a signal to mobile station 320 and mobile station 320 responds with an RSSI value, the signal strength is reported by mobile station 320. In either case, for the present example, a range may be estimated between the two mobile stations, for example, based at least in part on a signal strength value for a wireless communication between mobile station 320 and mobile station 600. Also, obtaining the signal strength value for a wireless communication between the mobile station 600 and mobile station 320 may comprise mobile station 600 sniffing an acknowledge signal transmitted by mobile station 320 and intended for access point 330 to determine the strength value based at least in part on a measured strength of the acknowledge signal as received at mobile station 600.

At block 570, a determination may be made as to whether the signal strength for the communication between mobile station 320 and mobile station 600 is greater than a pre-selected threshold. At least in part in response to the threshold being reached or exceeded, the process of the present example proceeds to block 580. Otherwise, no further action is taken, as indicated at block 575. That is, no action may be taken in this present example if mobile station 320 is not determined to be sufficiently close in range to mobile station 600 to perform the comparisons utilized in the present example with satisfactory results. In another example, at block 570, a determination may be made as to whether the estimated range between mobile station 320 and mobile station 600 is within a specified threshold. At least in part in response to the threshold not being reached or exceeded, the process proceeds to block 580. Otherwise, no further action is taken, as indicated at block 575.

Continuing with the present example, at block 580, a determination may be made as to whether a difference in signal strengths between the communications from access point 330 to mobile station 320 and from access point 330 to mobile station 600 is greater than a pre-selected threshold value. In particular, it may be determined whether a communication between access point 330 and mobile station 600 has a signal strength more than a threshold level lower than the signal strength of a communication between access point 330 and mobile station 320. If not, no further action is taken, as depicted at block 575. However, at least in part in response to communication between access point 330 and mobile station 600 having a signal strength more than a threshold level lower than the signal strength of the communication between access point 330 and mobile station 320, access point 330 may be filtered from use in position fix operations involving mobile station 600 (block 590). In this manner, if mobile station 600 and mobile station 320 are determined to be approximately equidistant to access point 330, and if the signal strength for a communication between mobile station 600 and access point 330 is at least a threshold value lower than the signal strength for a communication between mobile station 320 and access point 330, transmissions from access point 330 may be excluded, at least in part, from position fix operations involving mobile station 600.

Example implementations in accordance with claimed subject matter may include all, more than, or fewer than blocks 510-590. Further, the order of blocks 510-590 is merely an example order, and the scope of claimed subject matter is not limited in this respect.

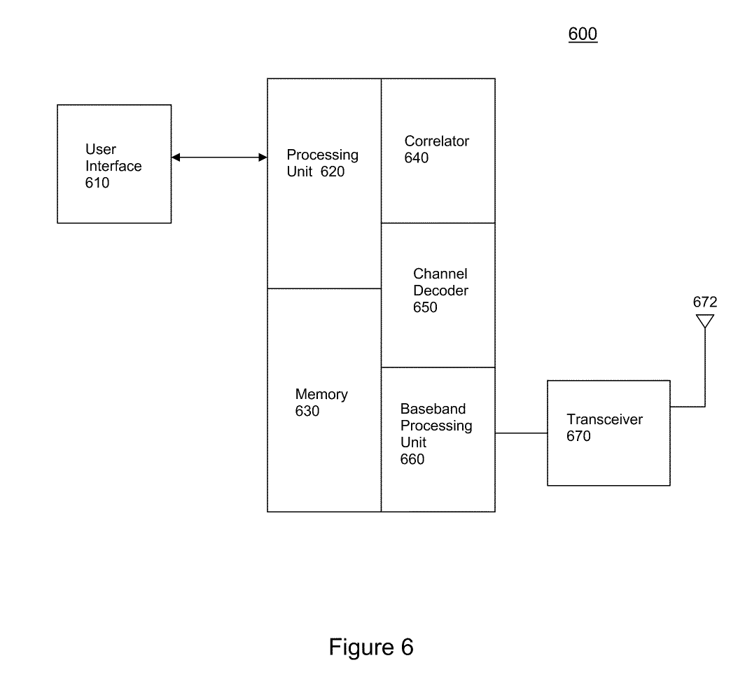

FIG. 6 is a block diagram illustrating example mobile station 600 that may be adapted to perform any of the example techniques described herein related to wireless terminals. One or more transceivers 670 may be adapted to modulate an RF carrier signal with baseband information, such as voice or data, onto an RF carrier, and demodulate a modulated RF carrier to obtain such baseband information. An antenna 672 may be adapted to transmit a modulated RF carrier over a wireless communications link and receive a modulated RF carrier over a wireless communications link.

A baseband processing unit 660 may be adapted to provide baseband information from a processing unit (PU) 620 to transceiver 670 for transmission over a wireless communications link. Here, PU 620 may obtain such baseband information from an input device within a user interface 610. Baseband processing unit 660 may also be adapted to provide baseband information from transceiver 670 to PU 620 for transmission through an output device within user interface 610.

User interface 610 may comprise a plurality of devices for inputting or outputting user information such as voice or data. Such devices may include, by way of non-limiting examples, a keyboard/keypad, a display/touch screen, a microphone, and a speaker.

Transceiver 670 may provide demodulated information to correlator 640. Correlator 640 may be adapted to derive beacon-related correlation functions from information relating to beacon signals provided by transceiver 670. This information may be used by mobile station 600 to acquire wireless communications services, for example from a wireless access point such as access point 330. Channel decoder 650 may be adapted to decode channel symbols received from baseband processing unit 660 into underlying source bits. In one example where channel symbols comprise convolutionally encoded symbols, such a channel decoder may comprise a Viterbi decoder. In a second example, where channel symbols comprise serial or parallel concatenations of convolutional codes, channel decoder 650 may comprise a turbo decoder.

Memory 630 may be adapted to store machine-readable instructions which are executable to perform one or more of processes, implementations, and/or examples thereof which are described and/or suggested herein. PU 620 may be adapted to access and execute such machine-readable instructions, thereby enabling mobile station 600 to perform one or more of the processes, implementations, and/or examples described and/or suggested herein, for example, in connection with FIGS. 1-5. Of course, mobile station 600 is merely an example, and the scope of claimed subject matter is not limited to the specific configuration of components and/or functional units depicted.

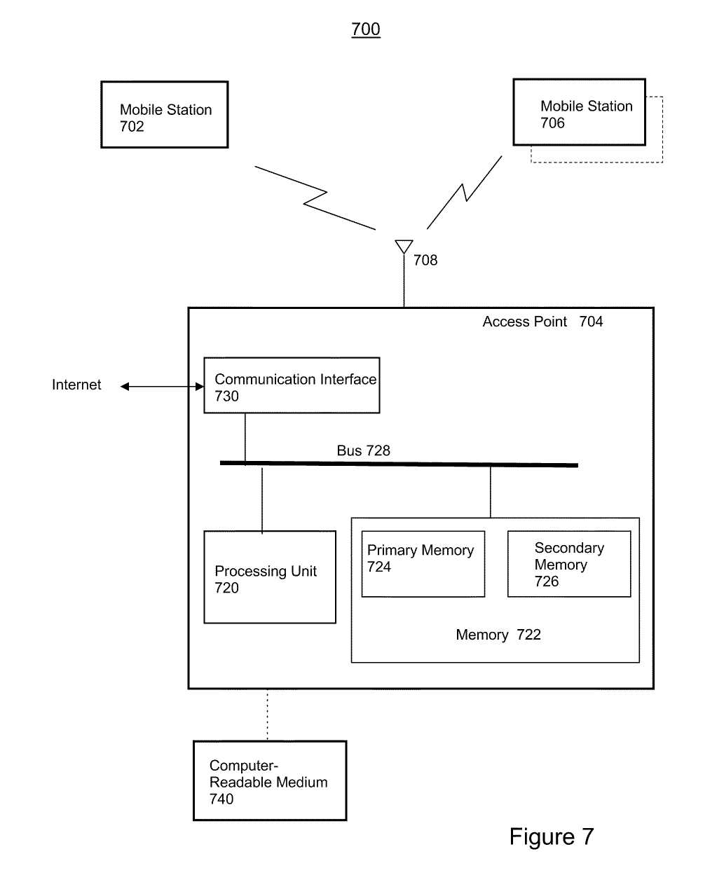

FIG. 7 is a schematic diagram illustrating a system that may include one or more devices adapted or adaptable to implement techniques and/or processes described, for example, in connection with example techniques depicted in FIGS. 1-6. System 700 may include, for example, a mobile station 702, an access point 704, and a mobile station 706. Mobile stations 702 and 706 may communicate with access point 704 via antenna 708 of access point 704.

Although devices 702 and 706 are depicted as mobile stations, these are merely examples of wireless terminals that may be representative of any device, appliance or machine that may be configurable to exchange data over a wireless communications network. By way of example but not limitation, access point 704 may comprise a stand-alone device including one or more radios, or access point 704 may be implemented as at least a portion of one or more computing devices and/or platforms, such as, e.g., a desktop computer, a laptop computer, a workstation, a server device, or the like, although the scope of claimed subject matter is not limited in this respect. Mobile stations 702 and/or 706 may comprise one or more personal computing or communication devices or appliances, such as, e.g., a personal digital assistant, mobile communication device, or the like.

Similarly, the wireless communications depicted between access point 704 and mobile stations 702 and 706, as shown in FIG. 7, is representative of any communication links, processes, and/or resources configurable to support the wireless exchange of data between access point 704 and one or more of mobile stations 702 and 706. As illustrated, for example, by the dashed lined box illustrated as being partially obscured by mobile station 706, there may be additional like devices establishing wireless communications with access point 704.

It is recognized that all or part of the various devices and networks, for example, shown in FIGS. 3 and 7, and the processes and techniques as further described herein, may be implemented using or otherwise including hardware, firmware, software, or any combination thereof.

Thus, by way of example but not limitation, access point 704 may include at least one processing unit 720 that is operatively coupled to memory 722 through bus 728.

Processing unit 720 is representative of one or more circuits configurable to perform at least a portion of a data computing procedure or process. By way of example but not limitation, processing unit 720 may include one or more processors, controllers, microprocessors, microcontrollers, application specific integrated circuits (ASICs), digital signal processors, programmable logic devices, field programmable gate arrays, and the like, or any combination thereof.

Memory 722 is representative of any data storage mechanism. Memory 722 may include, for example, primary memory 724 and/or secondary memory 726. Primary memory 724 may include, for example, a random access memory, read only memory, etc. While illustrated in this example as being separate from processing unit 720, it should be understood that all or part of primary memory 724 may be provided within or otherwise co-located/coupled with processing unit 720.

Secondary memory 726 may include, for example, the same or similar type of memory as primary memory and/or one or more data storage devices or systems, such as, for example, a disk drive, an optical disc drive, a tape drive, a solid state memory drive, etc. In certain implementations, secondary memory 726 may be operatively receptive of, or otherwise configurable to couple to, computer-readable medium 740. Computer-readable medium 740 may include, for example, any medium that can carry and/or make accessible data, code and/or instructions for one or more of the devices in system 700. Computer-readable medium 740 may also be referred to as storage medium.

Access point 704 may further include, for example, communication interface 730 that provides for or otherwise supports wireless communication with one or more wireless terminals such as mobile stations 702 and 706. Communication interface 730 may further support communication with a wired network such as the Internet as depicted in FIG. 7. By way of example but not limitation, communication interface 730 may include a network interface device or card, a modem, a router, a switch, a transceiver, a process, and/or the like.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices designed to perform the functions described herein, and/or combinations thereof.

For an implementation involving firmware and/or software, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processing unit. Memory may be implemented within the processing unit or external to the processing unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable medium may comprise an article of manufacture. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processing units to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. Again, these are merely examples of an instruction and claimed subject matter is not limited in this respect.

“Storage medium” as referred to herein relates to media capable of maintaining expressions which are perceivable by one or more machines. For example, a storage medium may comprise one or more storage devices for storing machine-readable instructions and/or information. Such storage devices may comprise any one of several media types including, for example, magnetic, optical or semiconductor storage media. Such storage devices may also comprise any type of long term, short term, volatile or non-volatile memory devices. However, these are merely examples of a storage medium, and claimed subject matter is not limited in these respects.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer/processing unit once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network, or any combination of the above networks, and so on. A CDMA network may implement one or more radio access technologies (RATs) such as cdma2000, Wideband-CDMA (W-CDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may comprise an IEEE 802.11x network, and a WPAN may comprise a Bluetooth network, an IEEE 802.15x network, for example. Wireless communication implementations described herein may also be used in connection with any combination of WWAN, WLAN and/or WPAN.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

As used herein, a mobile station (MS) refers to a device such as a cellular or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile station.”

The terms, “and,” “and/or,” and “or” as used herein may include a variety of meanings that will depend at least in part upon the context in which it is used. Typically, “and/or” as well as “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

1. A method, comprising:
estimating a range between a first mobile station and an access point; and
determining a confidence value related to the estimated range based, at least in part, on one or more signal attributes associated with wireless communications among the first mobile station, a second mobile station, and the access point.

2. The method of claim 1, wherein said determining the confidence value related to the estimated range between the first mobile station and the access point comprises:
obtaining a first signal strength value for a first wireless communication between the first mobile station and the access point;
obtaining a second signal strength value for a second wireless communication between the second mobile station and the access point; and
obtaining a third signal strength value for a third wireless communication between the first mobile station and the second mobile station.

3. The method of claim 2, wherein said estimating the range between the first mobile station and the access point comprises the first mobile station measuring a signal strength of a beacon signal transmitted by the access point.

4. The method of claim 3, wherein the first wireless communication comprises said beacon signal.

5. The method of claim 2, wherein said determining the confidence value related to the estimated range between the first mobile station and the access point further comprises determining the confidence value based, at least in part, on the first, second, and third wireless signal strength values.

6. The method of claim 5, wherein said determining the confidence value based, at least in part, on the first, second, and third wireless signal strength values comprises:
estimating a range between the first mobile station and the second mobile station based at least in part on said third signal strength value; and
determining the confidence value for the estimated range between the access point and the first mobile station by comparing the first signal strength value with the second signal strength value if said estimated range between the first mobile station and the second mobile station is within a specified threshold.

7. The method of claim 6, further comprising:
determining said confidence value to be high at least in part in response to the first signal strength value being approximately equal to the second signal strength value; and
determining said confidence value to be low at least in part in response to the first signal strength value being significantly lower than the second signal strength value.

8. The method of claim 7, further comprising excluding communications between the first mobile station and the access point from position fix operations at least in part in response to said confidence value being determined to be low.

9. The method of claim 2, wherein said obtaining the first signal strength value for the first wireless communication between the first mobile station and the access point comprises receiving a first received signal strength indicator (RSSI) value from the access point at the first mobile station.

10. The method of claim 9, wherein said obtaining the second signal strength value for the second wireless communication between the second mobile station and the access point comprises the first mobile station sniffing the second wireless communication to receive a second RSSI value included as part of the second wireless communication intended for the second mobile station.

11. The method of claim 10, wherein said obtaining the third signal strength value for the third wireless communication between the first mobile station and the second mobile station comprises the first mobile station sniffing an acknowledge signal transmitted by the second mobile station and intended for the access point to determine the third strength value based at least in part on a measured strength of the acknowledge signal as received at the first mobile station.

12. A mobile station, comprising:
a receiver to receive wireless communications;
a processing unit coupled to the receiver to estimate a range between a first mobile station and an access point, the processing unit further to determine a confidence value related to the estimated range based, at least in part, on one or more signal attributes associated with wireless communications among the mobile station, a second mobile station, and the access point.

13. The mobile station of claim 12, the receiver to:
obtain a first signal strength value for a first wireless communication between the mobile station and the access point;
obtain a second signal strength value for a second wireless communication between the second mobile station and the access point; and
obtain a third signal strength value for a third wireless communication between the mobile station and the second mobile station.

14. The mobile station of claim 13, the processing unit to estimate the range between the mobile station and the access point by measuring a signal strength of a beacon signal transmitted by the access point and received by the receiver.

15. The mobile station of claim 14, wherein the first wireless communication comprises said beacon signal.

16. The mobile station of claim 13, the processing unit further to determine the confidence value related to the estimated range between the mobile station and the access point by determining the confidence value based, at least in part, on the first, second, and third wireless signal strength values.

17. The mobile station of claim 16, the processing unit to determine the confidence value based, at least in part, on the first, second, and third wireless signal strength values by:
estimating a range between the mobile station and the second mobile station based at least in part on said third signal strength value; and
determining the confidence value for the estimated range between the access point and the mobile station by comparing the first signal strength value with the second signal strength value if said estimated range between the mobile station and the second mobile station is within a specified threshold.

18. The mobile station of claim 17, the processing unit to determine said confidence value to be high at least in part in response to the first signal strength value being approximately equal to the second signal strength value, and the processing unit further to determine said confidence value to be low at least in part in response to the first signal strength value being significantly lower than the second signal strength value.

19. The mobile station of claim 18, the processing unit to exclude communications between the mobile station and the access point from position fix operations at least in part in response to said confidence value being determined to be low.

20. The mobile station of claim 13, the receiver to obtain the first signal strength value for the first wireless communication between the mobile station and the access point by receiving a first received signal strength indicator (RSSI) value from the access point.

21. The mobile station of claim 20, the receiver to obtain the second signal strength value for the second wireless communication between the second mobile station and the access point by sniffing the second wireless communication to receive a second RSSI value included as part of the second wireless communication intended for the second mobile station.

22. The mobile station of claim 21, the receiver to obtain the third signal strength value for the third wireless communication between the mobile station and the second mobile station by sniffing an acknowledge signal transmitted by the second mobile station and intended for the access point to determine the third strength value based at least in part on a measured strength of the acknowledge signal as received at the receiver.

23. An apparatus, comprising:
means for estimating a range between a first mobile station and an access point; and
means for determining a confidence value related to the estimated range based, at least in part, on one or more signal attributes associated with wireless communications among the first mobile station, a second mobile station, and the access point.

24. The apparatus of claim 23, wherein said means for determining the confidence value related to the estimated range between the first mobile station and the access point comprises:
means for obtaining a first signal strength value for a first wireless communication between the first mobile station and the access point;
means for obtaining a second signal strength value for a second wireless communication between the second mobile station and the access point; and
means for obtaining a third signal strength value for a third wireless communication between the first mobile station and the second mobile station.

25. The apparatus of claim 24, wherein said means for estimating the range between the first mobile station and the access point comprises means for measuring a signal strength of a beacon signal transmitted by the access point.

26. The apparatus of claim 25, wherein the first wireless communication comprises said beacon signal.

27. The apparatus of claim 24, wherein said means for determining the confidence value related to the estimated range between the first mobile station and the access point further comprises means for determining the confidence value based, at least in part, on the first, second, and third wireless signal strength values.

28. The apparatus of claim 27, wherein said means for determining the confidence value based, at least in part, on the first, second, and third wireless signal strength values comprises:
means for estimating a range between the first mobile station and the second mobile station based at least in part on said third signal strength value; and
means for determining the confidence value for the estimated range between the access point and the first mobile station by comparing the first signal strength value with the second signal strength value if said estimated range between the first mobile station and the second mobile station is within a specified threshold.

29. The apparatus of claim 28, wherein said confidence value is determined to be high at least in part in response to the first signal strength value being approximately equal to the second signal strength value and wherein said confidence value is determined to be low at least in part in response to the first signal strength value being significantly lower than the second signal strength value.

30. The apparatus of claim 29, wherein if said confidence value is determined to be low, communications between the first mobile station and the access point are excluded from position fix operations related to the first mobile station.

31. The apparatus of claim 24, wherein said means for obtaining the first signal strength value for the first wireless communication between the first mobile station and the access point comprises means for receiving a first received signal strength indicator (RSSI) value from the access point at the first mobile station.

32. The apparatus of claim 31, wherein said means for obtaining the second signal strength value for the second wireless communication between the second mobile station and the access point comprises means for sniffing the second wireless communication at the first mobile station to receive a second RSSI value included as part of the second wireless communication intended for the second mobile station.

33. The apparatus of claim 32, wherein said means for obtaining the third signal strength value for the third wireless communication between the first mobile station and the second mobile station comprises means for sniffing an acknowledge signal transmitted by the second mobile station and intended for the access point to determine the third strength value based at least in part on a measured strength of the acknowledge signal as received at the first mobile station.

34. An article, comprising: a storage medium having stored thereon instructions executable by a first mobile station to:
estimate a range between the first mobile station and an access point; and
determine a confidence value related to the estimated range based, at least in part, on one or more signal attributes associated with wireless communications among the first mobile station, a second mobile station, and the access point.

35. The article of claim 34, wherein the storage medium has stored thereon further instructions executable by the first mobile station to determine the confidence value related to the estimated range between the first mobile station and the access point by:
obtaining a first signal strength value for a first wireless communication between the first mobile station and the access point;
obtaining a second signal strength value for a second wireless communication between the second mobile station and the access point; and
obtaining a third signal strength value for a third wireless communication between the first mobile station and the second mobile station.

36. The article of claim 35, wherein the storage medium has stored thereon further instructions executable by the first mobile station to estimate the range between the first mobile station and the access point by measuring a signal strength of a beacon signal transmitted by the access point.

37. The article of claim 36, wherein the first wireless communication comprises said beacon signal.

38. The article of claim 35, wherein the storage medium has stored thereon further instructions executable by the first mobile station to determine the confidence value related to the estimated range between the first mobile station and the access point by determining the confidence value based, at least in part, on the first, second, and third wireless signal strength values.

39. The article of claim 38, wherein the storage medium has stored thereon further instructions executable by the first mobile station to determine the confidence value based, at least in part, on the first, second, and third wireless signal strength values by:
estimating a range between the first mobile station and the second mobile station based at least in part on said third signal strength value; and
determining the confidence value for the estimated range between the access point and the first mobile station by comparing the first signal strength value with the second signal strength value if said estimated range between the first mobile station and the second mobile station is within a specified threshold.

40. The article of claim 39, wherein the storage medium has stored thereon further instructions executable by the first mobile station to determine said confidence value to be high at least in part in response to the first signal strength value being approximately equal to the second signal strength value and wherein the storage medium has stored thereon additional instructions executable by the first mobile station to determine said confidence value to be low at least in part in response to the first signal strength value being significantly lower than the second signal strength value.

41. The article of claim 40, wherein the storage medium has stored thereon further instructions executable by the first mobile station to exclude communications between the first mobile station and the access point from position fix operations at least in part in response to said confidence value being determined to be low.

42. The article of claim 35, wherein the storage medium has stored thereon further instructions executable by the first mobile station to obtain the first signal strength value for the first wireless communication between the first mobile station and the access point by receiving a first received signal strength indicator (RSSI) value from the access point at the first mobile station.

43. The article of claim 42, wherein the storage medium has stored thereon further instructions executable by the first mobile station to obtain the second signal strength value for the second wireless communication between the second mobile station and the access point by sniffing the second wireless communication to receive a second RSSI value included as part of the second wireless communication intended for the second mobile station.

44. The article of claim 43, wherein the storage medium has stored thereon further instructions executable by the first mobile station to obtain the third signal strength value for the third wireless communication between the first mobile station and the second mobile station by sniffing an acknowledge signal transmitted by the second mobile station and intended for the access point to determine the third strength value based at least in part on a measured strength of the acknowledge signal as received at the first mobile station.
